(19) United States
(12) Patent Application Publication
(10) Pub. No.: US 2010/0087999 A1
(43) Pub. Date: Apr. 8, 2010

(54) Apparatus and Method for Detecting End-of-Fill at Clutch in Automatic Transmission

(75) Inventors: Vijay A. Neelakantan, Rochester Hills, MI (US); Shushan Bai, Ann Arbor, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/244,979

(22) Filed: Oct. 3, 2008

(51) Int. Cl. F16D 25/12; G06F 17/00

(52) U.S. Cl. 701/67; 192/30 W

(57) ABSTRACT

An improved method and apparatus for detecting end-of-fill at a hydraulic clutch in an automatic transmission with a variable force solenoid are provided. The method includes: initiating clutch fill mode by commanding a high current to the solenoid whereby a high fluid pressure is delivered to the clutch apply volume; monitoring clutch fill time; determining if the fill time is greater than a threshold fill time; monitoring the current (e.g., actual and filtered) being actively drawn by the solenoid during clutch fill mode in response to the fill time being greater than the threshold fill time; detecting if an aberration occurs in the current; and stopping distribution of fluid to the hydraulic clutch in response to the current aberration. Detecting if an aberration occurs preferably includes determining a change in instantaneous armature velocity, and determining if the change in instantaneous velocity is greater than a threshold change in armature velocity.

### TECHNICAL FIELD

The present invention relates generally to motor vehicle powertrains, and more specifically to methods for detecting end-of-fill at a clutch in an automatic transmission, and devices for practicing the same.

### BACKGROUND OF THE INVENTION

Most automatic transmissions used in contemporary motor vehicles, such as the modern-day automobile, include a number of gear elements, generally in the nature of epicyclic planetary gear sets, for coupling the transmission's input and output shafts. Traditionally, a related number of hydraulically actuated torque establishing devices, such as clutches and brakes (the term “torque transmitting device” used hereinafter to refer to both clutches and brakes), are selectively engageable to activate the aforementioned gear elements for establishing desired forward and reverse speed ratios between the transmission's input and output shafts. The speed ratio is defined as the transmission input speed divided by the transmission output speed. Thus, a low gear range has a high speed ratio, whereas a high gear range has a lower speed ratio.

Shifting from one forward speed ratio to another is performed in response to engine throttle and vehicle speed, and generally involves releasing one or more “off-going” clutches associated with the current or attained speed ratio, and applying one or more “on-coming” clutches associated with the desired or commanded speed ratio. To perform a “downshift”, the transmission transitions from a low speed ratio to a high speed ratio. The downshift is accomplished by disengaging a clutch associated with the lower speed ratio, and contemporaneously engaging a clutch associated with the higher speed ratio, thereby reconfiguring the gear set to operate at the higher speed ratio. Shifts performed in the above manner are termed clutch-to-clutch shifts, and require precise timing in order to achieve high quality shifting.

The quality of a shift operation (e.g., a downshift or an upshift) depends upon the cooperative operation of several functions, such as pressure changes within the clutch apply chambers and the timing of control events. The engagement of a hydraulic clutch generally consists of two primary stages: the fill mode and the pressure modulation mode. In the fill mode, the clutch volume is rapidly filled with hydraulic fluid. In the pressure modulation mode, the pressure within the clutch volume is carefully modulated to ensure proper and full engagement of the clutch. After a predetermined time, the rate of filling is generally dropped to avoid pressure spikes when end-of-fill is reached.

Detecting end-of-fill at the clutch is extremely critical in controlling automatic transmissions, and prolonging transmission operational life expectancy. Variations in manufacturing tolerances in each transmission, changes due to component wear, inordinate piston stroke, variations in transmission fluid quality and temperature, fluid leakage, etc., will inherently affect clutch fill time. If the proper fill time is not known or accurately estimated, the controller may inadvertently “underfill” or “overfill” the clutch when attempting to modulate clutch pressure to fully engage the clutch. An “underfill” condition may result in “engine flare”—a sudden spike in engine speed, which leads to quicker wear of the clutch friction material. An “overfill” condition may result in “transmission tie-up”—inadvertent simultaneous engagement of both on-coming and off-going clutches, which deteriorates shift-feel, and may cause a shock load to the powertrain and the vehicle.

Adaptive control techniques, which estimate the fill times or fill volumes of the various clutches over a predetermined number of shifts involving each clutch, help to ameliorate some of the variability attributable to manufacturing tolerances, temperature, wear, and so on. Some prior art approaches, in an attempt to predict end-of-fill, use transmission input and output speed sensors to approximate underfill and overfill conditions. The time delay used to estimate clutch fill is adjusted based upon the transmission input speed. However, transient changes, that is, changes in the operating conditions that the controller has not adapted to, will affect the shift quality. Furthermore, a transient condition will have a negative effect on the fill time for the next shift without the transient condition.

In another attempt to more accurately predict end-of-fill, additional flow sensing valves or hydraulic pressure sensors may be used to detect pressure differentials at predetermined locations in the transmissions electro-hydraulic control system. The spool of the flow sensing valve, for example, closes a switch in response to a pressure differential that signals the end-of-fill condition. In a similar respect, a pressure detection switch that monitors hydraulic pressure may be used to predict the end of fill condition.

### SUMMARY OF THE INVENTION

According to one embodiment of the present invention, an improved method is provided for determining when a fluidly actuated torque transmitting device, such as a hydraulic clutch, in a power transmission is substantially filled with fluid—e.g., reaches an end-of-fill condition. The transmission has an electrically activated solenoid in operative communication with the torque transmitting device, and operable to regulate the same. The method includes: monitoring the active current being drawn by the solenoid during clutch fill—e.g., measuring the actual current, and determining a filtered current therefrom; detecting if an aberration occurs in the active current during clutch fill; and producing an end-of-fill signal in response to an aberration in the current.

According to one aspect of this embodiment, the method also includes initiating clutch fill mode prior to monitoring the active current. Initiating clutch fill mode includes commanding a high current and/or a high fluid pressure. Ideally, fill mode also includes monitoring clutch fill time. To this regard, the method preferably also includes determining if the fill time is greater than a threshold fill time. In this instance, monitoring the active current draw of the solenoid during clutch fill is executed in response to the fill time being greater than the threshold fill time.

According to another aspect of this particular embodiment, detecting if an aberration occurs includes determining a change in instantaneous velocity of the solenoid armature. To this regard, detecting if an aberration occurs preferably also includes determining if the change in instantaneous velocity is greater than a threshold change in armature velocity. Determining a change in instantaneous velocity is preferably based, at least in part, upon the inductance and resistance of the solenoid.

In accordance with another embodiment of the present invention, an improved method for detecting an end-of-fill condition at a hydraulic clutch in an automatic transmission is provided. The transmission has at least one electromagnetic solenoid. Each solenoid has an armature that is circumscribed by a coil, and movable in response to current flowing through the coil. The solenoid fluidly communicates a pressurized fluid source, such as a hydraulic pump and fluid reservoir, with the clutch apply volume, whereby the end-of-fill condition corresponds to the clutch apply volume being pressurized to a predetermined end-of-fill pressure by the solenoid.

The method of this embodiment includes: initiating clutch fill mode by commanding a high current to the solenoid, whereby a high fluid pressure is delivered to the clutch apply volume from the pressurized fluid source; monitoring clutch fill time; determining if the fill time is greater than a threshold fill time; monitoring the active current being drawn by the solenoid during clutch fill mode in response to the fill time being greater than the threshold fill time; detecting if an aberration occurs in the active current being drawn by the solenoid; and stopping distribution of fluid to the hydraulic clutch in response to the current aberration.

In accordance with one aspect of this embodiment, monitoring an active current includes measuring the actual current being drawn by the solenoid, and processing the actual current to determine a filtered (e.g., average) current.

In accordance with another aspect, detecting if an aberration occurs in the active current draw includes determining a change in instantaneous velocity of the solenoid armature. To this regard, detecting if an aberration occurs also includes determining if the change in instantaneous velocity is greater than a threshold change in armature velocity. Ideally, determining the change in instantaneous velocity is based upon certain solenoid parameters, which include, for example, the inductance, slope of inductance as a function of armature position, and resistance of the solenoid.

According to yet another embodiment of the present invention, a control apparatus for regulating activation of a hydraulic clutch in an automatic transmission is provided. The control apparatus includes a variable force solenoid (VFS) having a coil in operative communication with a transmission current source. The solenoid also includes a spool that operates to selectively fluidly communicate a pressurized fluid source with the clutch apply volume. An armature is connected to the spool, and circumscribed by the coil, whereby the armature operates to transition between a first and a second position in response to current flowing through the coil. A controller is in operative communication with the solenoid, and operates, at least in part, to control the movement of the armature. A sensor is in operative communication with both the solenoid and the controller. The sensor is configured to continuously monitor the current draw of the solenoid, and transmit signals indicative thereof to the controller.

The controller is programmed and configured to selectively initiate clutch fill mode by commanding a high current to the solenoid coil, whereby a high fluid pressure is delivered to the clutch apply volume from the pressurized fluid source through the solenoid. The controller is also programmed and configured to monitor the clutch fill time, and determine if the fill time is greater than a threshold fill time. If so, the controller is further programmed and configured to measure and monitor the active draw of current by the solenoid during clutch fill mode. In addition, the controller is programmed and configured to detect if an aberration occurs in the active current, and to stop distribution of fluid to the hydraulic clutch in response to the current aberration. Detecting if an aberration occurs includes determining a change in instantaneous velocity of the solenoid armature.

According to one aspect of this embodiment, the solenoid is in direct fluid communication with the hydraulic clutch. To this regard, the solenoid is preferably a high-flow, direct acting variable force solenoid (VFS) that is operable to control both clutch fill and clutch modulation. It is also desired that the sensor which monitors solenoid current draw is a closed-loop current controller.

The above objects, features, and advantages, and other objects, features, and advantages of the present invention will be readily apparent from the following detailed description of the preferred embodiments and best mode for carrying out the present invention when taken in connection with the accompanying drawings and appended claims.

### BRIEF DESCRIPTION OF THE DRAWINGS

FIG. 1 is a schematic diagram of a control apparatus for regulating activation of a hydraulic clutch, and detecting end-of-fill of the hydraulic clutch in accordance with the present invention;

FIG. 2 is a graphical representation of the relationship between solenoid current draw and clutch end-of-fill in accordance with the present invention; and

FIG. 3 is a flow chart or block diagram illustrating a method for detecting an end-of-fill condition at a hydraulic clutch in an automatic transmission in accordance with a preferred embodiment of the present invention.

### DESCRIPTION OF THE PREFERRED EMBODIMENT

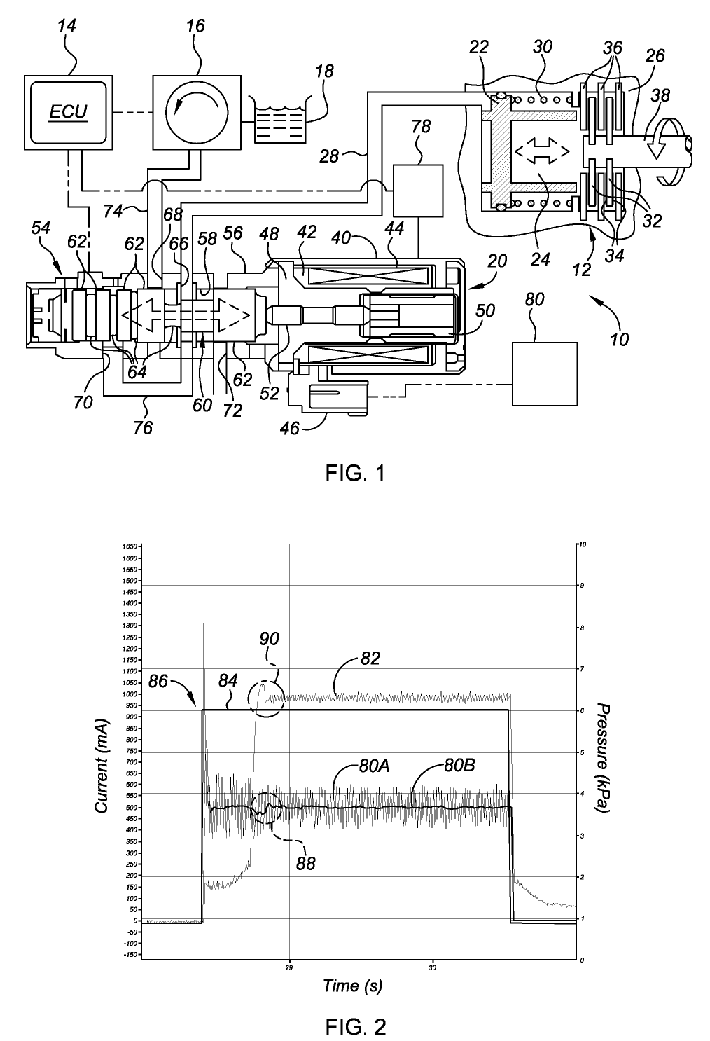

The present invention is described herein in the context of an electro-hydraulic control system for a multi-ratio automatic transmission. The portion of the electro-hydraulic control system shown in FIG. 1 hereof has been greatly simplified, it being understood that further information regarding the fluid pressure routings and general operation of a power transmission may be found in the prior art. Furthermore, it should be readily understood that FIG. 1 is merely an exemplary application by which the present invention may be incorporated and practiced. Accordingly, the present invention is by no means limited to the particular configuration presented in FIG. 1.

Referring to the drawings, wherein like reference numbers refer to like components throughout the several views, a portion of an electro-hydraulic control system for a power transmission is schematically illustrated in FIG. 1, and designated generally at 10. The control system 10 (also referred to as “control apparatus”) is represented herein by a fluidly actuated torque transmitting device, namely hydraulic clutch 12, a controller or electronic control unit (ECU) 14 of conventional architecture, a source of pressurized fluid, such as pump 16 and reservoir 18, and an electrically activated solenoid, shown in FIG. 1 as a high-flow, direct acting variable force solenoid (VFS) 20.

The hydraulic clutch 12 includes an apply piston 22 slidably disposed inside of a piston chamber 24 (also referred to herein as “apply volume”) defined by a piston housing 26. The clutch apply volume 24, through piston housing 26, is in direct fluid communication with the solenoid 20 by a clutch feed path, which is defined at least partially by first hydraulic conduit 28. The piston 22 is urged into a disengaged position (as seen in FIG. 1) by a biasing member, shown as return spring 30. The torque-transmitting device 12 also includes a plurality of friction plates 32 drivingly connected with or splined to a shaft member 38. Each friction plate 32 has a coating or layer of friction material 34. The friction plates 32 are interspersed with a plurality of reaction plates 36 that are drivingly connected with or splined to the piston housing 26. The friction and reaction plates 32, 36 cooperate to form a conventional clutch pack.

The hydraulic clutch 12 is shown in FIG. 1 in a disengaged state, wherein the fluid pressure in the piston chamber 24 is essentially zero. However, as will be explained below, a slight pressure may be maintained within the piston chamber 24 to ensure that the passages remain filled with fluid when the clutch 12 is disengaged. During operation of the clutch 12, fluid will be rapidly distributed from the pump 16 into the apply volume 24 by the solenoid 20. When the pressure in the piston chamber 24 is sufficient to overcome the force of return spring 30, the piston 22 is urged into an engaged state (e.g., rightward in FIG. 1), translating axially to push against the clutch pack, and frictionally engage the adjacent faces of the plates 32, 36. As pressure is modulated, the piston will compress the friction and reaction plates 32, 36, drivingly connecting the shaft member 38 with the piston housing 26. At full engagement, the solenoid 20 will regulate the pressure within the piston chamber 24 to maintain the clutch engaged at the desired torque level. As will be explained in extensive detail hereinbelow, the solenoid 20 is operable to control both fill and modulation of the hydraulic clutch 12.

The clutch assembly shown in FIG. 1 is an exemplary hydraulic torque transmitting device, provided to aid in understanding some key features and parameters of the present invention. To this regard, the hydraulic clutch 12 may take on any known configuration without departing from the intended scope and spirit of the present invention. By way of example, and not limitation, the hydraulic clutch 12 may be a reaction clutch assembly (e.g., wherein the piston housing 26 is integral with or attached to a stationary member, generally a portion of the transmission housing, to ground the rotating member 38 upon engagement of piston 22), or a rotating clutch assembly (e.g., wherein the piston housing 26 is integral with or attached to a driven element, such as a constituent part of an epicyclic planetary gear set, to drivingly transfer torque thereto from the shaft member 38 upon engagement of piston 22).

With continuing reference to FIG. 1, the solenoid 20 has a housing 40 enclosing a bobbin 42. The bobbin 42 has a primary electromagnetic coil 44 wound thereon. A terminal 46 electrically connects the electromagnetic coil 44 to a source of electricity and, preferably, direct current, such as battery 80. The solenoid housing 40 defines a channel 48 elongated along, and generally coaxial with the longitudinal axis of the bobbin 42. An armature 50 is co-axially disposed within the channel 48. An actuator rod 52 is operatively attached to, and slides co-axially with armature 50.

A spool valve, indicated generally at 54 in FIG. 1, is located immediately adjacent to the housing 40 of the solenoid 20. The spool valve 54 has a valve body or sleeve 56 that is coupled to one end of the housing 40, proximate to an interface end of the actuator rod 52. The valve body 56 defines a bore 58 that extends along the longitudinal axis of the valve body 56 and juxtaposed to the channel 48 of the solenoid housing 40. A generally cylindrical spool 60 is disposed within the bore 58, and slidable along the longitudinal axis of the bore 58 of the valve body 56. The spool 60 has an array of cylindrical landing portions 62 of varying diameters, separated by respective substantially cylindrical groove portions 64. The spool 60 is operatively connected to, and preferably coaxially aligned with the solenoid actuator rod 52 for common movement therewith.

The valve body 56 has a clutch feed passage 66, a supply passage 68, a feedback passage 70, and an exhaust port 72. The clutch feed passage 66 (also known as “control pressure”) fluidly communicates the spool valve body 56 with the piston housing 26 via first hydraulic conduit 28. In a similar respect, the supply passage 68 (also known as “line pressure”) fluidly communicates the spool valve body 56 with the pump 16 via second hydraulic conduit 74, generally through a line pressure regulator valve (not shown herein). In addition, the feedback passage 70 is in fluid communication with the clutch feed passage 66 via third hydraulic conduit 76. The feedback passage 70 is used by the solenoid 20 to regulate output pressure from clutch feed passage 66. Finally, the exhaust port 72 is fluidly connected to the reservoir 18 or a backfill pressure circuit (not explicitly illustrated herein) to maintain a very low pressure (generally less than 5 psi) to keep the circuits filled with fluid even when the clutch 12 is disengaged.

According to the embodiment of FIG. 1, the control apparatus 10 is a closed-loop control system, providing a constant feed of current to the solenoid 20. When the solenoid 20 is energized—i.e., current is passed from the battery 48 through the electromagnetic coil 44, the armature 50 is moved by the electromagnetic force created by the induced magnetic flux generated in the coil. For example, when the solenoid 20 is energized with a particular polarity, the armature 50 will move to a first, activated position (e.g., to the left as shown in FIG. 1). The actuator rod 52 will, in turn, push the spool 60 to a clutching position. Movement of the spool 60 to a clutching position will fluidly connect the clutch feed passage 66 to the supply passage 68, directing pressurized fluid from the pump 16 to the clutch apply volume 24. When the polarity in the solenoid 20 is reversed, the armature 50 and, thus, the actuator rod 52 will move to a declutching position (e.g., in a rightward direction in FIG. 1), which moves the spool 60 to a second, deactivated position (e.g., to the right as shown in FIG. 1). Movement of the spool 60 to a declutching position redirects pressure from the clutch feed passage 66 to the exhaust port 72.

The solenoid 20 also operates to modulate pressure to the hydraulic clutch 12. That is, the current flow through the primary electromagnetic coil 44 can be manipulated to moving the armature 50 to intermittent positions between the clutching and declutching positions. Specifically, when the clutch pressure is being regulated, the clutch feed passage 66 is selectively open to the supply passage 68, and the feedback passage 70 is used to regulate the solenoid position.

The electronic portion of the control system 10 is primarily defined by the ECU 14, which is depicted in FIG. 1 in a representative embodiment as a microprocessor-based electronic control unit of conventional architecture. The ECU 14 functions to control the operation of the various subcomponents of the control system 10, such as the pump 16 and solenoid 20, based on a number of inputs to achieve a desired transmission speed ratio. Such inputs may include, but are not limited to, signals representing the transmission input speed (TIS), a driver torque command (TQ), the transmission output speed (TOS), and the hydraulic fluid temperature (TSUMP). The sensors traditionally employed for developing such signals may be conventional in nature. One such sensor is shown at 78, and is in signaling communication with both the ECU 14 and solenoid 20. The sensor 78, which is preferably a closed-loop current controller, is configured to continuously monitor the current draw of the solenoid, and transmit signals indicative thereof to the ECU 14.

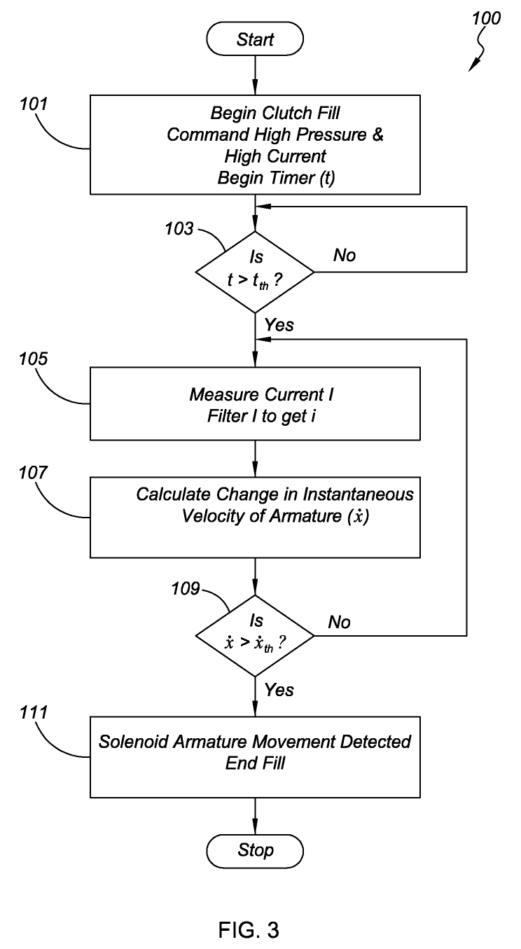

A method of detecting an end-of-fill condition at a hydraulic clutch in an automatic transmission in accordance with a preferred embodiment of the present invention is depicted in block diagram format in FIG. 3, and indicated generally as 100. The method 100 of detecting end-of-fill (e.g., when the clutch volume is substantially filled with fluid, or when the clutch apply volume is pressurized to a predetermined end-of-fill pressure) is described herein with respect to the structure illustrated in FIG. 1. However, the present invention may be integrated into various other applications without departing from the intended scope of the present invention. To that regard, the present invention may be applied to any application employing a controller or ECU, an electromagnetic solenoid, and one or more hydraulic torque transmitting devices.

Looking to FIG. 3, the method 100 begins at step 101 with initiating clutch fill mode. Clutch fill mode generally includes commanding a high current to the solenoid 20, which shifts the spool 60 to the clutching position as described above, whereby a high fluid pressure is delivered to the clutch apply volume 24 from the pressurized fluid source—i.e., pump 16 which draws hydraulic fluid from reservoir 18, through the clutch feed path. For example, the controller 14 computes the required pressure at the clutch 12 for a particular shift. The required clutch pressure is then converted to a commanded current (e.g., using a P-I pressure-current map). The controller 12 then sends a high frequency (often in the nature of 3000 Hz) PWM signal to produce the commanded current. Ideally, the controller 14 also adds a tunable “dither” to the commanded current. A “dither” is a lower frequency (e.g., 300 Hz), low-amplitude component that keeps the solenoid “loose” and ready to respond quickly. The dither is intended to minimize the “stickiness” of the solenoid 20 attributable, for example, to contamination. As such, the actual current will include the dynamic response to the PWM command and the dither command together. The controller 14 preferably uses a closed loop current control method to make sure the actual current tracks the commanded current. It should be recognized, however, that the method 100 need not actively initiate clutch fill to determine end-of-fill and regulate clutch activation in accordance with the present invention.

Step 101 also includes monitoring the clutch fill time—“Begin Timer (t)”, and determining, in step 103, if and when the fill time (t) is greater than a threshold fill time (tₜₕ). When the clutch fill process is started (e.g., step 101), there is a step change in the current command to the solenoid 20. FIG. 2 of the drawings plots the time-varied relationship between current draw of the solenoid 20, measured in mille-amps (mA), and the pressure inside of the clutch apply chamber 24, measured in kilopascals (kPa). In the exemplary embodiment of FIG. 2, the actual and filtered solenoid current draw are indicated at 80A and 80B, respectively, the clutch pressure is indicated at 82, and the current command is identified by reference numeral 84. Due to system parameters, like the Inductance and Resistance of the solenoid coil 44 and the controller parameters, the actual current drawn by the solenoid 20 will follow a typical transient response, indicated generally at 86 in FIG. 2, before settling to a steady state. There will be noticeable oscillations in actual and filtered current 80A, 80B during this transient period, which should preferably be disregarded in practicing the present method 100. The estimated value of threshold fill time (tₜₕ) will be equal to the settling time of the system, which can be verified by system identification methods and experimentation. If the clutch fill time (t) is not greater than the threshold fill time (tₜₕ), the method 100 repeats step 103.

If the clutch fill time (t) does exceed the threshold fill time (tₜₕ), the method 100 responds, in step 105, by measuring and monitoring the active current being drawn by the solenoid 20 during clutch fill mode (e.g., using sensor 78). Monitoring the active current being drawn by the solenoid 20 preferably includes measuring the actual current 80A, and processing the actual current 80A using a standard signal filter, such as, but certainly not limited to, a Kalman filter, a Butterworth filter, a low-pass or high-pass filter, etc., to determine the filtered current 80B.

Contemporaneous therewith, or after step 105, the method 100 then includes detecting if an aberration or irregularity occurs in the active current drawn by the solenoid 20 during clutch fill. One such aberration is shown for explanatory purposes at 88 in FIG. 2. The aberration 88 is substantially concurrent in time with the end-of-fill of the clutch 12, which is indicated in FIG. 2 at 90.

According to step 107 of FIG. 3, detecting if an aberration occurs in the active current draw includes determining a change in instantaneous velocity (\dot{x}) of the solenoid armature 50. Specifically, the positional change of the spool 60, and thus the armature 50 of the high-flow VFS 20 after the clutch 12 is filled is reflected as a change in the waveform of the current drawn—e.g., 88 in FIG. 2. This is because the solenoid 20 moves from a high flow regime to a pressure control regime. At the end-of-fill, the flow of oil reduces and there is more feedback pressure on the solenoid and this force imbalance causes the solenoid to move. This positional change in the solenoid armature 50 is reflected in the current drawn by the solenoid due to changes in the back-emf (electromotive force) and the equivalent inductance change due to the change in the overall magnetic circuit. The instantaneous armature velocity (\dot{x}) is equal to the Voltage (V) across the coil 44 minus the product of the coil inductance (L) and rate of change in current (di/dt), minus the product of the current (i) and Resistance (R) across the coil 44, all divided by the product of the current (i) and the slope of inductance as a function of position of the armature (L′(x)).

\dot{x}=(V−L(di/dt)−iR)/(iL′(x))

Detecting end-of-fill at the clutch 12 in accordance with the present invention removes the need for pressure switches that are required in some prior art methodologies, resulting in space and cost savings. The present invention is also independent of clutch volume, which may change over time as indicated above, as well as transmission input and output speeds, which vary from shift-to-shift under different transient operating conditions.

In step 109, the method 100 includes determining if the change in instantaneous velocity (\dot{x}) is greater than a threshold change in armature velocity (\dot{x}ₜₕ). Due to inherent noise in measuring the instantaneous velocity (\dot{x}), there will always be some calculated change in the velocity of the armature 50 even during steady state conditions. To eliminate the possibility of a premature end-of-fill signal, and capture only the change when the armature moves after fill, the method 100 includes the threshold value (\dot{x}ₜₕ), which is determined by the amount of noise in the system measurements. If the change in instantaneous velocity (\dot{x}) is not greater than the threshold change in armature velocity (\dot{x}ₜₕ), the method 100 returns to step 105. If the change in instantaneous velocity (\dot{x}) is greater than the threshold change in armature velocity (\dot{x}ₜₕ), the method 100 will produce an end-of-fill signal, and command stoppage of the distribution of fluid to the hydraulic clutch 12 at step 111.

The method 100 of the present invention preferably includes at least steps 101-111. However, it is within the scope and spirit of the present invention to omit steps, include additional steps, and/or modify the order presented in FIG. 3. It should be further noted that the method 100 depicted in FIG. 3 represents a single cycle in detecting an end-of-fill condition at a hydraulic clutch. As such, it is contemplated, but not required, that the method 100 be applied in a systematic and continuous manner.

While the best modes for carrying out the invention have been described in detail, those familiar with the art to which the instant invention relates will recognize various alternative designs and embodiments for practicing the invention within the scope of the appended claims.

1. A method for determining when a fluidly actuated torque transmitting device in a power transmission is substantially filled with fluid, the transmission having an electrically activated solenoid in operative communication with the torque transmitting device to regulate the same, the method comprising:
monitoring an active current being drawn by the solenoid during clutch fill;
detecting if an aberration occurs in said active current; and
producing an end-of-fill signal in response to said aberration in said active current.

2. The method of claim 1, wherein said monitoring an active current includes measuring an actual current and determining a filtered current.

3. The method of claim 1, further comprising:
initiating clutch fill mode prior to said monitoring said active current, said initiating clutch fill mode including commanding at least one of a high current and a high fluid pressure.

4. The method of claim 3, wherein said initiating fill mode further includes monitoring a fill time.

5. The method of claim 4, further comprising:
determining if said fill time is greater than a threshold fill time;
wherein said monitoring an active current is in response to said fill time being greater than said threshold fill time.

6. The method of claim 1, wherein the solenoid includes an armature circumscribed by a coil and movable in response to current flowing in the coil; and wherein said detecting if an aberration occurs includes determining a change in instantaneous velocity of the armature.

7. The method of claim 6, wherein said detecting if an aberration occurs further includes determining if said change in instantaneous velocity is greater than a threshold change in armature velocity.

8. The method of claim 6, wherein determining a change in instantaneous velocity is based at least in part upon an inductance and a resistance of the solenoid.

9. A method for detecting an end-of-fill condition at a hydraulic clutch in an automatic transmission, the hydraulic clutch having an apply volume, the transmission having at least one electromagnetic solenoid with an armature circumscribed by a coil and movable in response to current flowing through the coil, the at least one solenoid fluidly communicating a pressurized fluid source with the clutch apply volume whereby the end-of-fill condition corresponds to the clutch apply volume being pressurized to a predetermined end-of-fill pressure by the solenoid, the method comprising:
initiating clutch fill mode by commanding a high current to the solenoid whereby a high fluid pressure is delivered to the clutch apply volume;
monitoring a fill time;
determining if said fill time is greater than a threshold fill time;
monitoring an active current being drawn by the solenoid during clutch fill mode in response to said fill time being greater than said threshold fill time;
detecting if an aberration occurs in said active current; and
stopping distribution of fluid to the hydraulic clutch in response to said aberration in said active current.

10. The method of claim 9, wherein said monitoring an active current includes measuring an actual current being drawn by the solenoid, and processing said actual current to determine a filtered current.

11. The method of claim 9, wherein said detecting if an aberration occurs includes determining a change in instantaneous velocity of the armature.

12. The method of claim 11, wherein said detecting if an aberration occurs further includes determining if said change in instantaneous velocity is greater than a threshold change in armature velocity.

13. The method of claim 11, wherein determining a change in instantaneous velocity is based at least in part upon an inductance, slope of inductance as a function of armature position, and a resistance of the solenoid.

14. A control apparatus for regulating activation of a hydraulic clutch with an apply volume in an automatic transmission having a pressurized fluid source and a current source, the control apparatus comprising:
a variable force solenoid having a coil in operative communication with the current source, a spool selectively fluidly communicating the pressurized fluid source with the clutch apply volume, and an armature operatively connected to the spool and circumscribed by said coil, whereby said armature operates to transition between a first and a second position in response to current flowing through said coil;
a controller in operative communication with said solenoid, and operable to control transition of said armature; and
a sensor in operative communication with said solenoid and said controller, and configured to continuously monitor current drawn by said solenoid and transmit signals indicative thereof to said controller;
wherein said controller is programmed and configured to selectively initiate clutch fill mode by commanding a high current to the solenoid coil whereby a high fluid pressure is delivered to the clutch apply volume from the pressurized fluid source;
wherein said controller is programmed and configured to monitor a fill time and determine if said fill time is greater than a threshold fill time;
wherein said controller is programmed and configured to monitor an active current being drawn by said solenoid during clutch fill mode in response to said fill time being greater than said threshold fill time;
wherein said controller is programmed and configured to detect if an aberration occurs in said active current, and to stop distribution of fluid to the hydraulic clutch in response to said aberration in said active current; and
wherein said detecting if an aberration occurs includes determining a change in instantaneous velocity of the armature.

15. The control apparatus of claim 14, wherein said detecting if an aberration occurs further includes determining if said change in instantaneous velocity is greater than a threshold change in armature velocity.

16. The control apparatus of claim 14, wherein said monitoring an active current includes measuring an actual current being drawn by said solenoid, and processing said actual current to determine a filtered current.

17. The control apparatus of claim 14, wherein determining a change in instantaneous velocity is based at least in part upon an inductance, slope of inductance as a function of armature position, and a resistance of said solenoid.

18. The control apparatus of claim 14, wherein said solenoid is in direct fluid communication with the hydraulic clutch.

19. The control apparatus of claim 14, wherein said solenoid is a high-flow direct acting variable force solenoid operable to control both clutch fill and clutch modulation.

20. The control apparatus of claim 14, wherein said sensor is a closed-loop current controller.
